(19) United States
(12) Patent Application Publication
(10) Pub. No.: US 2014/0145522 A1
(43) Pub. Date: May 29, 2014

(54) Electromagnetic Digital Materials

(71) Applicants: Neil A. Gershenfeld, Somerville, MA (US); Nadya M. Peek, Cambridge, MA (US); Ernest Rehmi Post, CAmbridge, MA (US); William Kai Langford, Greenwich, CT (US)

(72) Inventors: Neil A. Gershenfeld, Somerville, MA (US); Nadya M. Peek, Cambridge, MA (US); Ernest Rehmi Post, CAmbridge, MA (US); William Kai Langford, Greenwich, CT (US)

(73) Assignee: MASSACHUSETTS INSTITUTE OF TECHNOLOGY, Cambridge, MA (US)

(21) Appl. No.: 13/972,876

(22) Filed: Aug. 21, 2013

Related U.S. Application Data
(63) Continuation-in-part of application No. 13/669,434, filed on Nov. 5, 2012.
(60) Provisional application No. 61/691,733, filed on Aug. 21, 2012.
(60) Provisional application No. 61/555,747, filed on Nov. 4, 2011.

(51) Int. Cl. H01F 1/00

(52) U.S. Cl. CPC H01F 1/00
USPC 310/10; 29/602.1; 335/296

(57) ABSTRACT

Electromagnetic digital materials are made up of a set of voxels, some of which are made from electromagnetically active materials. Each voxel is adapted to be assembled into a structure according to a regular physical geometry and an electromagnetic geometry, and a majority of the voxels in the set are reversibly connectable to other voxels. Voxels in the set may differ in material composition or property from other voxels in the set. Voxels may be arranged into multi-voxel parts that are assembled into the structure according to a regular physical geometry and the electromagnetic geometry. Electromagnetic structures may be made from the electromagnetic digital material, and may be fabricated by an automated process that includes assembling a set of voxels by reversibly connecting the voxels to each other according to a regular physical geometry and an electromagnetic geometry and assembling the reversibly connected voxels into the electromagnetic structure.

### RELATED APPLICATIONS

This application claims the benefit of U.S. Provisional Application Ser. No. 61/691,733, filed Aug. 21, 2012, the entire disclosure of which is herein incorporated by reference.

This application is a continuation-in-part of U.S. patent application Ser. No. 13/669,434, filed Nov. 5, 2012, which claims the benefit of U.S. Provisional Application Ser. No. 61/555,747, filed Nov. 4, 2011, the entire disclosures of which are herein incorporated by reference.

### STATEMENT REGARDING FEDERALLY SPONSORED RESEARCH OR DEVELOPMENT

This invention was made with U.S. government support under Grant Number W911NF-11-1-0096, awarded by the Army Research Office. The government has certain rights in this invention.

### FIELD OF THE TECHNOLOGY

The present invention relates to digital materials and, in particular, to electromagnetic digital materials.

### BACKGROUND

Digital materials are comprised of a small number of types of discrete physical building blocks that may be assembled to form constructions that have a level of versatility and scalability that is analogous to that of digital computation and communication systems. Digital materials promise scalable methods of producing functional things with reconfigurable sets of discrete and compatible parts.

In general, a digital material is made up of a discrete number of parts (also referred to as components or voxels) that have a finite number of connections. Digital materials have specifically been defined in prior work by Popescu as having three main properties at the highest level of description: a finite set of components or discrete parts, a finite set of discretized joints of all components in a digital material, and complete control of assembly and placement of discrete interlocking components [Popescu, G., Gershenfeld, N. and Marhale, T., “Digital Materials For Digital Printing”, International Conference on Digital Fabrication Technologies, Denver, Colo., September 2006]. The components can be of any size and shape, made out of various materials, and can fit together in various ways. The components of digital materials generally must satisfy the conditions that each component can be decomposed into a finite number of smaller geometrical shapes, that two components can only make a small finite number of different connections (links), and that the connection between any two components is reversible.

Digital systems consist of discrete parts that exhibit error-correcting behavior—if the error remains below the threshold designed into the digital system, the digital system itself remains precise. Digital materials comprise a digital system wherein there is a finite number of components that make up the material, there is a finite number of joints that can be formed between the components, and the assembly process can control how the components are placed [G. Popescu, “Digital Materials for Digital Fabrication”, Master's thesis, Massachusetts Institute of Technology, Cambridge, Mass., 2007]. These criteria (discrete parts, discrete joints, and explicit placement) allow the resulting material to be multi-material, fully recyclable, and locally tunable using component properties. Since digital parts are error-correcting and self-aligning, they can be assembled into structures with higher accuracy than the placement accuracy of the assembling person or machine.

Current manufacturing techniques generally employ digital computation and communication algorithms to control analog mechanical equipment that additively or subtractively forms shapes from masses of bulk material. Most current rapid-prototyping machines are fundamentally continuous or analog processes. Although many fabrication machines are digitally-controlled, these machines still must continuously cut or add material to make parts. Rapid prototyping machines can be broken into two categories: additive and subtractive fabrication machines. Although both additive and subtractive rapid prototyping processes are becoming more accessible and affordable, they are still material-dependent processes, they are still fundamentally continuous or analog, and the fabrication process is not reversible.

Additive prototyping machines typically build models by extruding a material in a liquid state, and then the material hardens or is hardened after exiting the print head. Several additive methods that use discrete components to create an analog material as a final product are known in the art. Selective laser sintering (SLS) uses high power lasers to fuse powders such as glass, metal or thermoplastics, creating forms that are irreversible. The powders are not analog, but are initially formless particles that are discrete and separate. Upon fusing a particle to another, a new analog material is created that is continuous and attached to adjacent particles to form the larger object. Another such additive method is fused deposition modeling (FDM). FDM takes a coil of thermoplastic or metal wire and deposits material from an extruder by heating and melting the material. Stereolithography (SLA) is similar to SLS, but instead of using powder, it uses a vat of liquid with a high power laser to create the part in cured layers [Bourell, D. L., Leu, M. C. & Rosen, D. W. (Eds.), “Roadmap for Additive Manufacturing: identifying the Future of Freeform Processing”, Austin, Tex., The University of Texas at Austin Laboratory for Free-fora Fabrication, 2009]. Electron beam melting (EBM) is another additive process, using an electron beam to melt metals such as titanium in powder form. Similar to previous processes, each part is built one layer at a time, solidified, and then a subsequent layer is built. Current additive manufacturing technologies may utilize the same materials used in manufacturing processes, but the final products rarely behave per material specification, always depend on the machine used to make them for surface resolution, and any error in the part generates wasted material.

Conventional subtractive manufacturing processes take solid blocks or sheets of material and machine out material by drilling or milling from the existing material to create the final part. The initial material is analog in nature, but often these discrete parts are combined within larger assemblies using irreversible joining and bonding methods, which again render the assemblies irreversible, with surface resolution depending on the machine tools used, and any error in the part means waste of the entire assembly of materials. CNC milling machines are a common form of subtractive machining; these machines use a high-speed spindle or router to cut wood, plastic, steel, or other machineable materials. Subtractive machining also results in an object for which the precision is governed by the machine that manufactures it.

Subtractive and additive manufacturing processes have long been the norm for electronics production, using methods like lithography or micromachining to pattern elements onto bulk materials [H. Kaeslin, “Digital Integrated Circuit Design: From VLSI Architectures to CMOS Fabrication”, 2008]. There are several problems with how electronics are currently made. Additive processes have started replacing subtractive ones for high-throughput production, but it is still difficult to print high-Q structures. Furthermore, as devices grow in complexity and size they impose ever-greater requirements on process control, increasing cost and decreasing yield. For example, it is very hard to make circuit boards that aren't flat. Issues of density have conventionally been solved by using multi-layer circuit boards, but they are very costly due to things like blind and buried vias. Finally, traditionally-fabricated electronic devices cannot easily be reused, resulting in millions of tons of electronic waste each year.

For any given additive or subtractive process, representation of the initial model and translation from initial design to final product requires greater integration than the available tools currently offer. Unlike analog materials, the components of digital materials determine the final resolution of the object they make up, and they can be more precise than the machine that is used to assemble them due to their error-correcting properties.

Digital material systems are a method for fabrication from discrete parts with discrete relative local positioning, instead of continuous variation of composition and location of material, as in an analog fabrication system. Structures that are created from multiple material types allow explicit control over design and optimization parameters. Digital materials can be constructed out of rigid, flexible, transparent, opaque, conductors, insulators, semiconductors, lightweight, or heavy materials. Digital materials allow any or all of these materials to be assembled within the same assembly. A multiple material digital assembly can be built by one multi-material digital assembler machine. Multi-material 3D printers already exist, but the parts are not reversible and the material palette is limited to some rigid photopolymers and elastomers. The materials can be assembled by a digital assembler machine. The assembler may also be a disassembler, or a separate machine may take on the tasks of disassembling, sorting, and delivering parts back to the assembler machine. The reversible connections of digital materials allow the same parts to be reused and reconfigured without waste or degrading the quality of the material. For example, physically digital conductors and insulators can make reconfigurable 3D circuits. Physically digital active electronics also opens up the possibility of having discrete transistors with reversible connections to make devices such as reconfigurable ASICs or other devices that can be reprogrammed by changing the physical configuration of the parts making up a device.

A digital material desktop printer, now called the MTM Snap, was the first application constructed entirely out of discrete, snap-fit, reversible digital materials The entire structure for the MTM Snap is made up of a finite set of discrete parts, with built-in flexural connections and slots that are all milled as one CAD file on any CNC shopbot machine. The parts for the machine are made of high density polyethylene, which as a material demonstrates great potential to create robust and stiff flexural connections, although it can be made out of many other suitable materials. The entire machine can be fabricated within a day, with additional motors and tool heads installed depending on the fabrication method desired. These digital material printers can print or mill their own parts, in order to replicate and build more machines like themselves.

MIT's Center for Bits and Atoms has taken the digital material printer to the next level by incorporating a pick and place mechanism to create a digital material assembler, which is a machine that picks and places each newly fabricated piece to create the final form. Jonathan Hiller (Cornell University) has also previously constructed a voxel assembling machine that assembles structures made up of many spherical voxels and deposits an adhesive to bind the spheres together. Hiller's assemblies were shown to be reversible and reusable by dissolving the adhesive binder and separating the parts by material type for reuse.

A press-fit interference connection may be used rather than adhesives for connecting parts. Press-fit connectors permit reversibility and eliminate the use of adhesive binder. A press-fit connection is a joint that holds together by friction or micro bonding between surfaces. Press-fit connections are also referred to as interference fit, because one part is essentially interfering with the space of another. One common press-fit part design is a slotted connection which mates with another slot to create an interference fit connection. This slot acts as a clamp that flexes when its mate part interferes with the space the other part occupies. This clamping mechanism is essentially a flexure, which can be designed and tuned to exert a specific force while also providing a snap-lock release mechanism for ease of reversibility. The flexing part can be used for an interlocking mechanism, which can give a press-fit connection more strength than the material itself. In other words, when two press fit parts are put in maximum tension, the material will break before the connection separates. A release mechanism added to a flexure can provide controlled reversibility, allowing one part to be disconnected from the structure without putting significant force on the rest of the assembly.

Digital materials have already been proposed for certain types of manufacturing [G. Popescu, N. Gershenfeld, and T. Mahale, “Digital materials for digital printing”, DF 2006 International Conference on Digital Fabrication Technologies, Denver Colo., 2006; J. Hiller and H. Lipson, “Design and analysis of digital materials for physical 3D voxel printing”, Rapid Prototyping Journal, vol. 15, no. 2, 2009; J. Hiller and H. Lipson, “Tunable digital material properties for 3D voxel printers”, Rapid Prototyping Journal, vol. 16. No. 4, 2010; J. D. Hiller and H. Lipson, “Fully recyclable multi-material printing”, Proceedings of the Solid Freeform Fabrication Symposium, 2009; G. Popescu, “Digital Materials for Digital Fabrication”, Master's thesis, Massachusetts Institute of Technology, Cambridge, Mass., 2007], and preliminary designs for assemblers that place or recycle digital materials have also been proposed [G. Popescu, P. Kunzler, and N. Gershenfeld, “Digital Printing of Digital Materials”, DF 2006 International Conference on Digital Fabrication Technologies, Denver Colo., 2006; J. Ward, “Additive Assembly of Digital Materials”, Master's thesis, Massachusetts Institute of Technology, 2010; S. Griffith, D. Goldwater, and J. M. Jacobson, “Self-replication from random parts”, Nature, vol. 437, no. 29, 2005; G. M. Whitesides and B. Grzybowski, “Self-assembly at all scales”, Science, vol. 295, no. 5564, pp. 2418-2421, 2002]. However, there has not previously been a study of digitally fabricated electromagnetic devices.

### SUMMARY

Digital materials are used for electromagnetic structures, wherein conductive, resistive, and insulating voxels are used to build up any electromagnetic device. Design and assembly methods have been developed for electromagnetic passives like capacitors, strip lines, resistors, and inductors. As a digital material system, electromagnetic digital materials can be included in kits-of-parts with few primitive part types that can produce functionally useful assemblies, which have life cycle efficiencies exceeding that of conventional engineered fabrication methods.

Electromagnetic digital materials according to the invention provide a codable and reversible method of assembling electromagnetic structures. The material is made up of voxels, each connected to others around it on a lattice. Their joints are error correcting, reversible, and allow a finite number of connections to be made. This, along with the selection of materials for the voxels, allows local connections to govern specific electromagnetic properties of a larger structure. Types of electromagnetic digital materials developed include resistive, conductive, insulator, dielectric, and semiconductor voxels. Additively assembled electromagnetic digital materials according to the invention offer a new mode of electronic device fabrication, permitting new device geometries and device disassembly and reuse.

In one aspect of the invention, electromagnetic digital material is made up of a set of voxels made of one or more subsets of identical voxels, at least some of which are made from electromagnetically active materials. Each voxel is assembled, or adapted to be assembled, into a structure according to a regular physical geometry and an electromagnetic geometry, and a majority of the voxels in the set are each reversibly connected, or adapted to be reversibly connected, to at least two other voxels in the set according to the regular physical and electromagnetic geometries. At least some of the voxels in the set may differ in material composition or property from other voxels in the set. Voxels in the set may include voxels made from insulating, conducting, resistive, semiconductor, and/or magnetic materials. Voxels may be arranged into a set of multi-voxel parts and the multi-voxel parts may be assembled into the structure according to a multi-voxel part regular physical geometry and the electromagnetic geometry. The voxels may be reversibly connected, or adapted to be reversibly connected, by press-fit connections. The subsets of voxels may have differing shapes and voxels having differing shapes may be connectable to each other.

In another aspect of the invention, an electromagnetic structure is made from electromagnetic digital material. The electromagnetic digital material is made up of a set of voxels made of one or more subsets of identical voxels, at least some of which are made from electromagnetically active materials. Each voxel is assembled, or adapted to be assembled, into an electromagnetic structure according to a regular physical geometry and an electromagnetic geometry, and a majority of the voxels in the set are each reversibly connected, or adapted to be reversibly connected, to at least two other voxels in the set according to the regular physical and electromagnetic geometries. At least some of the voxels in the set may differ in material composition or property from other voxels in the set. Electromagnetic structures that can be made from electromagnetic digital material may include, but are not limited to, a circuit lattice, motors, and electronic devices, such as capacitors, inductors, and diodes.

In a further aspect of the invention, an automated process for fabricating an electromagnetic structure includes the steps of assembling a set of voxels, wherein at least some of the voxels are made from electromagnetically active materials, by reversibly connecting the voxels to each other, each of the voxels being reversibly connected, or adapted to be reversibly connected, to at least two other voxels in the set according to a regular physical geometry and an electromagnetic geometry; and assembling the reversibly connected voxels into the electromagnetic structure according to the regular physical geometry and the electromagnetic geometry. The automated process may be controlled by a specially adapted processor implementing a computer algorithm. The electromagnetic properties of the electromagnetic structure produced by the process may be tuned by changing one or more of the following: the ratio of different types of voxels used to assemble the electromagnetic structure, the shape of the different types of voxels used to assemble the electromagnetic structure, the material properties of the different types of voxels used to assemble the electromagnetic structure, and the physical geometry of the electromagnetic structure.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is an exemplary digital material geometry that can be used as an alternative to printed circuit boards for components with SOIC-pitch, according to one aspect of the invention;

FIGS. 2A-B depict exemplary hierarchical voxels fabricated from electromagnetic materials, showing scalability and vertical interconnect between self-similar parts according to one aspect of the present invention;

FIG. 3 depicts exemplary H and O geometry voxels that provide conductive and resistive elements for digital circuitry when fabricated from copper and polycarbonate;

FIG. 4 depicts part of an exemplary prototype inductor in assembly;

FIG. 5 depicts several exemplary primitive voxels used to populate a lattice structure with interlocking mechanical pieces;

FIG. 6 depicts examples of multi-voxel parts of different materials that may be used to compose larger structures;

FIG. 7 depicts several of the primitives shown in FIG. 5 combined into an exemplary multi-voxel part that interlocks with other parts;

FIG. 8 depicts an exemplary capacitor assembled from conducting and insulating multi-voxel parts;

FIG. 9A depicts an exemplary multi-voxel part and FIG. 9B depicts an exemplary inductive coil comprised of conductive parts as shown in FIG. 9A separated by insulating parts;

FIG. 10 depicts an alternate exemplary embodiment of a multi-voxel conducting part that has multiple post and hole geometries in one part;

FIG. 11 depicts an exemplary square spiral inductor composed of conducting and insulating multi-voxel parts;

FIG. 12 depicts an exemplary diode ohmic junction created from copper, N-doped silicon, and lead GIK press-fit digital material parts;

FIGS. 13A-D depict an exemplary embedded actuator composed of digital materials;

FIG. 14 is depicts an exemplary distributed actuator composed of digital materials;

FIG. 15 depicts an exemplary schematic of an interdigitated capacitor made up of discrete voxels;

FIG. 16 depicts simple tiling in the x and y directions for the capacitor of FIG. 15;

FIG. 17 depicts the voxel type used for the prototype capacitor and inductor implementations shown in FIGS. 18 and 19;

FIG. 18 depicts a prototype implementation of a capacitor made from the voxel type shown in FIG. 17;

FIG. 19 depicts a prototype implementation of an inductor made from the voxel type shown in FIG. 17;

FIG. 20 is a graph of the capacitance of the exemplary discrete capacitor of FIG. 18 as a function of the number of vertical units (capacitance per unit height);

FIG. 21 is a graph showing the results of time-domain analysis on the exemplary discrete capacitor of FIG. 18;

FIG. 22 is a graph showing the results of time-domain analysis on the exemplary discrete inductor of FIG. 19;

FIG. 23 is a magnified view of a portion of the circuit lattice of FIG. 24, constructed using the voxel of FIG. 17;

FIG. 24 is a schematic of an exemplary circuit lattice constructed using the voxel of FIG. 17;

FIG. 25 is a schematic of an exemplary 3-dimensional circuit lattice constructed using the voxel of FIG. 17;

FIG. 26 depicts an exemplary embodiment of a digital inchworm assembler having single degree-of-freedom ratchet-type locomotion;

FIG. 27 depicts the exemplary digital inchworm assembler of FIG. 26 with a part dispenser; and

FIG. 28 depicts two of the digital inchworm assemblers of FIG. 26 in place, constructing a circuit lattice.

### DETAILED DESCRIPTION

Functional digital materials, along with new circuit (electromagnetic) geometries and fabrication methods that allow for disassembly and reuse, are used according to the present invention to fabricate electromagnetic structures and circuits. Electromagnetic digital materials apply the digital manufacturing paradigm to the assembly of electromagnetic systems. These digital materials are constructed from a small set of discrete parts, made of electromagnetically active materials, such as, but not limited to, conductive, resistive, dielectric, semiconductor, magnetic, or insulating material, that fit together in a coded manner with discrete orientations. Using a finite set of voxels, any electromagnetic component or structure can be assembled, such as inductors, capacitors, filters, striplines, matching networks, feeds, splitters, and couplers.

As used herein, the following terms expressly include, but are not to be limited to:

“Analog” means information or physical matter that is represented as a continuous quantity.

“Analog material” means any continuous material or any material used to create a bulk material with special properties, such as, but not limited to, thermoplastics deposited continuously or a solid block of wax. All additive manufacturing processes use materials that are analog in nature.

“Digital” means information or physical matter that is represented as discrete quantities or values, depending on the user-defined representation of the system. The term ‘digital’ in digital fabrication is not to be confused with this definition.

“Digital fabrication” means the use of tools and manufacturing processes that permits taking parts as initial CAD representations, and to then create prototypes that are closer to the final product by using analog materials.

“Digital material” means a material made out of components wherein the set of all the components used in a digital material is finite (i.e. discrete parts), the set of the all joints the components of a digital material can form is finite (i.e. discrete joints), and the assembly process has complete control over the placement of each component (i.e. explicit placement).

“Electromagnetic material” or “Electromagnetically active material” means a digital material that is made from a material that can be used in the construction of electromagnetic structures, including, but not limited to, resistive, conductive, insulating, dielectric, semiconductor, and/or magnetic materials.

“Electromagnetic geometry” generally means the electrical and magnetic pathways that together create a specific electromagnetic structure. More specifically, it means the precise configuration of electromagnetic materials required to achieve a specific electrical or magnetic function within an electromagnetic structure. In the context of electromagnetic digital materials, the electromagnetic geometry is the precise physical arrangement of voxels composed of differing materials and differing shapes that is required to achieve the intended function of the electromagnetic structure.

“Hierarchical digital material” means a digital material that consists of components that can connect to self-similar components and have a variable size.

“Voxel” means an individual component of a digital material. A voxel has a finite number of connections to other voxels. Voxels can take the form of shape components or connectors.

As previously described, digital assembly uses a wide range of materials and allows arbitrary sizing with interconnect between self-similar parts at different length scales. The components (voxels) can achieve this connection through horizontal or vertical assembly. A digital material construction set can be fabricated at many scales. In other words, the voxel size within the same structure can range from arbitrarily small to arbitrarily large, limited only by the ability to fabricate voxels at a given scale. Since hierarchical digital materials allow voxel size to be variable within the same model, a structure can not only consist of multiple types of materials but also have variable feature sizes and density. This hierarchical scalability permits a wider range of applications by allowing tunable construction of assemblies with varying feature sizes and voxel density.

The present invention employs electromagnetic digital materials for discrete assembly of electromagnetic structures such as, but not limited to, electronic circuits. This includes not only the circuit board, but also the passive and active electronic components which make up any electrical circuit. With electrically conducting and insulating elements, any electrical network can be snapped together, as can inductors and capacitors. With two semiconducting elements, active electronic components like diodes and transistors can be made, permitting the creation of digital logic circuits.

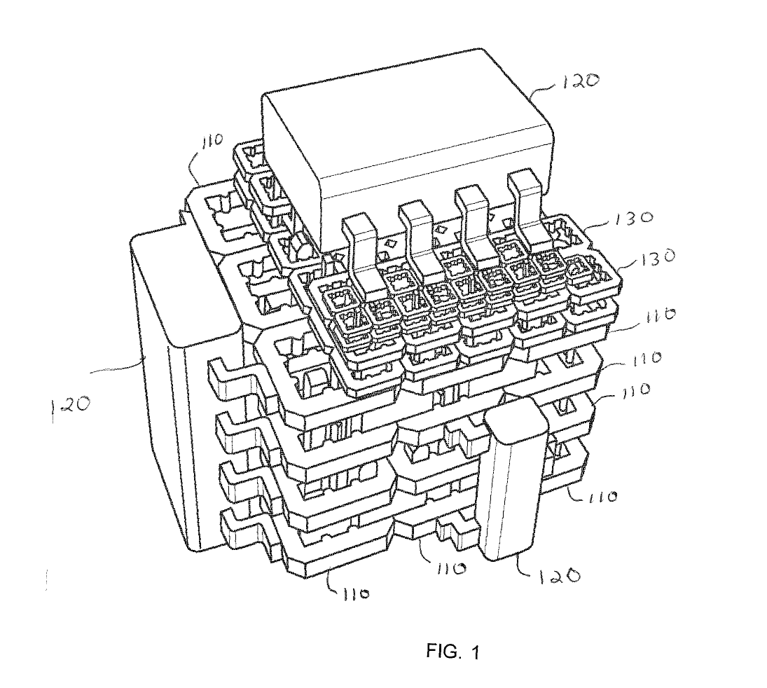

FIG. 1 depicts an example of a digital material geometry which can be used as an alternative to printed circuit boards for components with SOIC-pitch [J. Ward. Additive Assembly of Digital Materials. Master's thesis, Massachusetts Institute of Technology, 2010]. Prototype SOIC-pitch circuit boards with conductor and insulator parts roughly 5 mm in the longest dimension were assembled. These parts can be hierarchical to change size within the structure or to tune traces or current levels. As seen in the embodiment depicted in FIG. 1, three sizes of press fit parts are vertically assembled to allow SOIC-pitch electrical components to connect to any exterior face of the structure. Parts shown are made from conductive material 110 and insulating material 120, 130. The entire structure forms a circuit that is reconfigurable and can be disassembled.

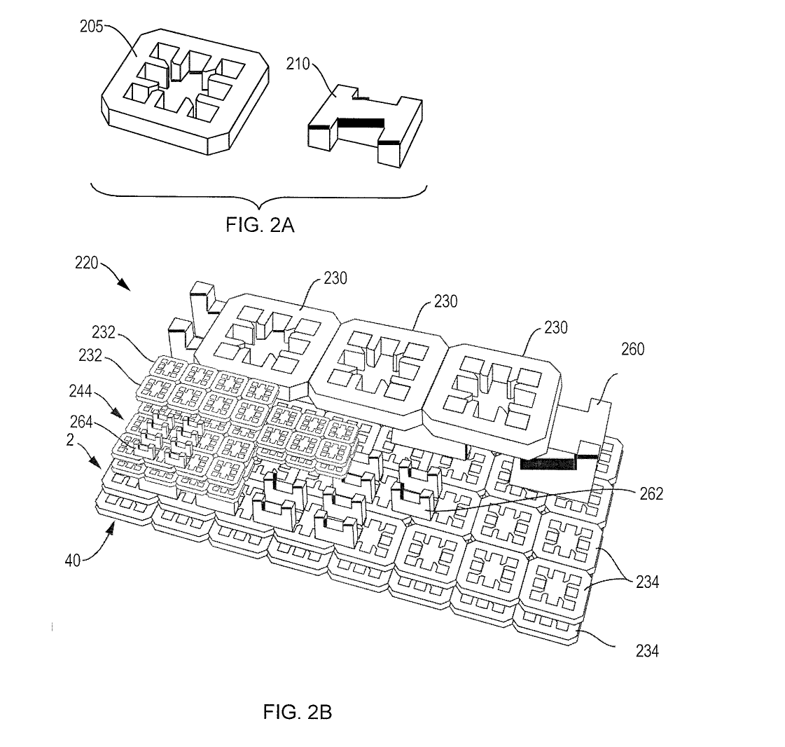

FIGS. 2A and 2B depict exemplary hierarchical voxels fabricated from electromagnetic materials, showing scalability and vertical interconnect between self-similar parts according to an aspect of the present invention. In FIGS. 2A and 2B, voxels of shape 205 and connector 210 are used in several different sizes to assemble structure 220. Different sizes of voxels 230, 232, 234 of type 205 are interconnected with voxels of the same type 205 and size into horizontal layers 240, 242, 244 by means of connectors 260, 262, 264 of type 210. The layers are then vertically assembled by means of connectors 260, 262, 264 of type 210 in order to connect each layer to other layers of the same or different size. In the structure shown in FIG. 2B, voxels 230 and connectors 260 are fabricated from conducting materials, while voxels 232, 234 and connectors 262, 264 are fabricated from insulating material.

Digital material parts may be fabricated from any materials chosen for their electromagnetic properties, as long as they are mechanically compatible for assembly. Suitable materials used in prototypes include, but are not limited to, aluminum, bronze, polycarbonate, and carbon fiber composite sheet stock. These materials were chosen for their suitability as resistive, insulating, or conductive elements, as well as their machining properties. It will be clear to one of skill in the art that many other materials have these properties and therefore would also be suitable. The prototypes were fabricated by CNC machining, but it will also be clear to one of skill in the art that mass production could employ other methods, such as, but not limited to, coining stamps and other press molds, as milling each voxel individually is not likely to efficiently scale up to the volumes of voxels needed in electromagnetic devices.

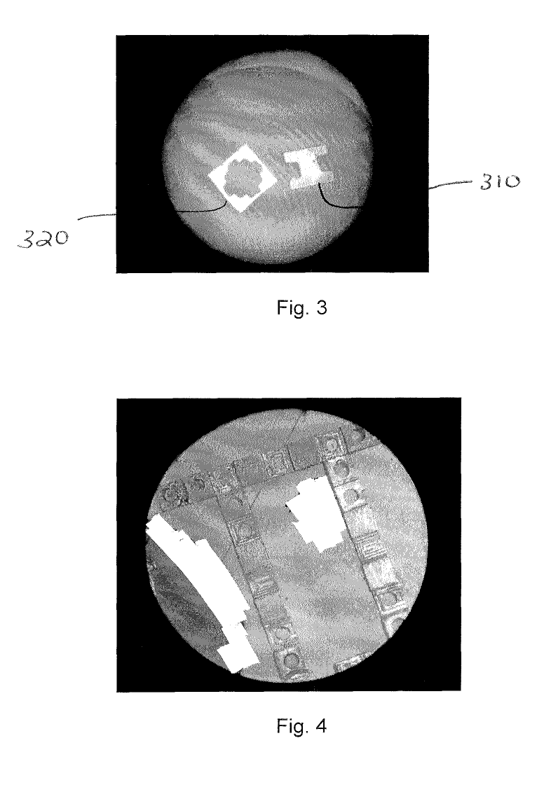

The geometry of the voxels employed depends at least in part on the size of the application envisioned and the number of voxels to be assembled. Exemplary electromagnetic digital material voxels were milled from copper and polycarbonate, their shape deriving from the H and O geometry originally proposed in U.S. patent application Ser. No. 13/669,434, which has been incorporated by reference herein, and in J. Ward, “Additive Assembly of Digital Materials”, Master's thesis, Massachusetts Institute of Technology, 2010. FIG. 3 depicts exemplary H 310 and O 320 geometry voxels that provide conductive and resistive elements for digital circuitry when fabricated from copper and polycarbonate, respectively. The voxels employed for the prototype were milled on a mini-mill and are 2.5 mm in width. These parts are small enough to be able to form circuits along with non-digital parts like microcontrollers, in SOIC pitch.

These resistive, insulating, and conductive voxels may be assembled by hand or by an automated assembly device into electromagnetic structures. FIG. 4 depicts part of an exemplary prototype inductor in assembly. An inductor such as the one depicted in FIG. 4 is made by snapping together the appropriate number of voxels. It will be clear to one of skill in the art that, while many geometries are suitable, as a practical matter the part geometry selected will at least in part depend on how the chosen digital assembler functions in practice.

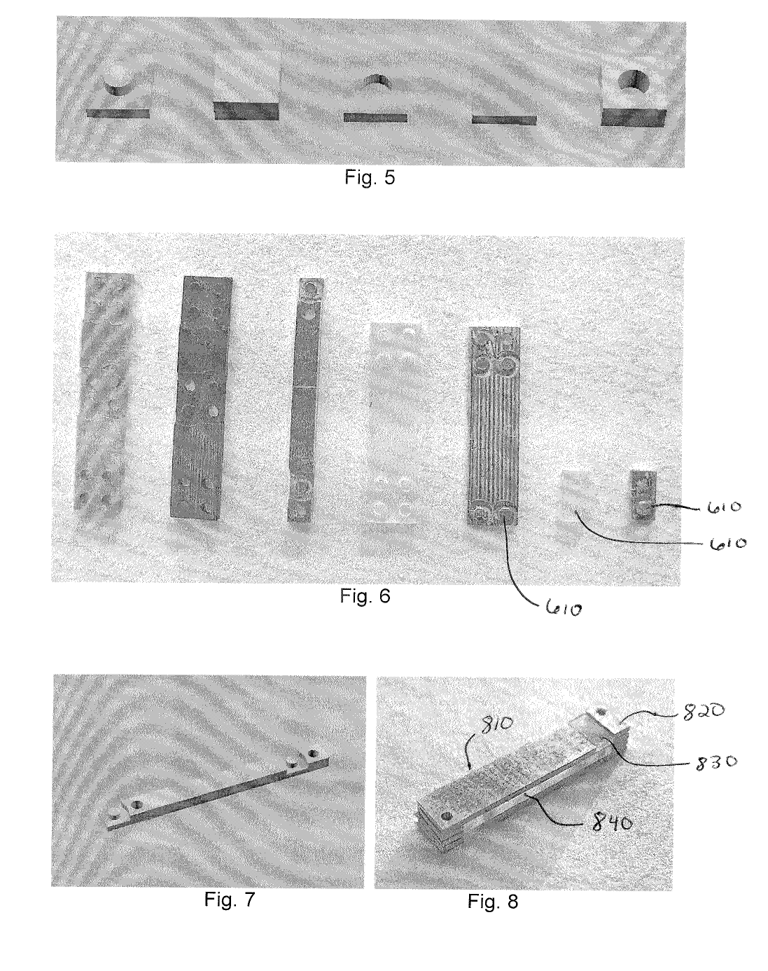

Another possible geometry is the post-and-hole type. This geometry is particularly interesting for manufacturing multi-voxel parts for use in particular structures such as inductors. This is possible only in the OO part of an O-H geometry. FIG. 5 depicts several primitive voxels used to populate a lattice structure with interlocking mechanical pieces. In this embodiment, the feature size scale is 0.0125 inch, post and hole diameters are 0.025 inch, part thickness is 0.025 inch max, and unit cell size is 0.050×0.050×0.025 inch. Other feature sizes may be chosen, so long as the materials used are compatible with the scale.

To be able to use electromagnetic digital materials, the fabricator generates a voxelized description or code for the part to be constructed (e.g. a capacitor), and then snaps the corresponding parts together to form the part. In the exemplary case of a capacitor, a layer of conductive parts is separated by a layer of insulating parts from another layer of conductive parts. If the structure (in this example, the capacitor) is to be embedded in a larger electromagnetic system, this can also be constructed from the same digital material (e.g. the capacitor may be connected via a stripline to an inductor). If the electromagnetic structure becomes deprecated, the part can be disassembled into voxels and reused in other electromagnetic structures.

The modular structure of electromagnetic digital materials allows them to be used in many electromagnetic applications, including applications that use analog electromagnetics for some of the parts of the structure. This permits novel and hybrid electromagnetic applications to be explored that are not possible with conventional manufacturing geometries, processes, and methods.

There are several routes from specification to realization of a digitally-assembled electromagnetic device. Structures are assembled from voxels of differing properties on a lattice. Design of these structures can be done by placing each voxel manually, hierarchically, algorithmically, or by other methods. For example, in manual placement, an inductor might be implemented by drawing a conductive helix surrounding a ferromagnetic volume on the lattice. In hierarchical placement, a parameterized model might draw the required conductive and ferromagnetic structures. In algorithmic placement, an initial structure might be placed and then improved via convex optimization of voxel placements.

After voxels of differing electromagnetic properties have been placed, the lattice is populated with parts specific to the digital assembly process and the feedstock of parts. Ideally, voxels are placed that are no more and no less than the specified volume of material, but, in order to make stable structures with reversible electrical, magnetic, and mechanical contact between voxels, there must be interlocking connections between adjacent voxels.

An example of interlocking elements which can be assembled from one preferred direction (i.e. bottom-up) is embodied by the LEGO™ brand of toy bricks. Two lessons taken from LEGO™ are the plug-and-socket connections between bricks and the use of multi-voxel elements to uniformly fill volumes more quickly than would be possible with individual voxels. There is no loss of generality as long as the assembler can manipulate these multi-voxel elements without undue complication. It is therefore feasible to keep a wider variety of voxels than the fundamental primitives in the assembler's feedstock.

After the electromagnetically relevant voxels are placed, it is simpler to populate the remainder of the lattice with voxel-parts of maximum size when building structures by hand. In one example, the primitive parts shown in FIG. 5 are used to create extended structures. This is an example of hierarchical design, wherein an electromagnetic device is assembled from several copies of two parts.

Some examples of such multi-voxel parts are shown in FIG. 6, wherein each multi-voxel part comprises from 2-22 voxels. FIG. 6 depicts examples of multi-voxel parts of different materials, which may be used to compose larger structures that take advantage of their conductive, resistive, and insulating properties. The parts are milled from bronze, carbon fiber sheet stock, and polycarbonate. The gender of the connection sites is selected depending on how they occupy the lattice. The feature size of a post 610 in FIG. 6 is 0.3 mm.

FIG. 7 depicts several of the primitives shown in FIG. 5, combined into an exemplary multi-voxel part that interlocks with other parts. This exemplary rendering also includes cutouts to allow fabrication by CNC milling with an end mill of diameter comparable to the feature size.

FIG. 8 depicts an exemplary capacitor assembled from conducting 810, 820 (phosphor bronze) and insulating 830, 840 (polycarbonate) multi-voxel parts.

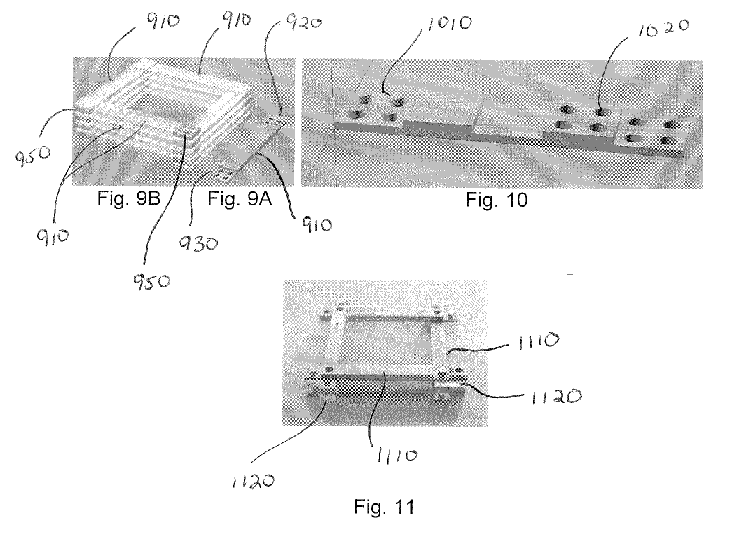

Using multi-voxel parts allows for the rapid assembly of repetitive structures such as inductors, capacitors, and other passive electromagnetics. FIG. 9A depicts an exemplary multi-voxel part 910 that has multiple connection sites 920, 930. FIG. 9B depicts an exemplary inductive coil comprised of conductive parts 910 from FIG. 9A separated by small square insulating parts 950. Conducting parts 910 are 1.5 mm by 10 mm, with a post feature 960 size of about 0.3 mm.

FIG. 10 depicts an alternate embodiment of a multi-voxel conducting part that has multiple post 1010 and hole 1020 geometries in one part, allowing for more reconfigurability and different resistive properties depending on attachment sites.

FIG. 11 depicts an exemplary square spiral inductor composed of conducting 1110 (phosphor bronze) and insulating 1120 (polycarbonate) multi-voxel parts.

The parts were generated by a script that converted a specification string into a solid geometry, which was then converted into a tool path for fabricating prototype parts. The parts were then assembled by hand into the structures shown in FIGS. 8 and 11.

The values of the electromagnetic structures can be varied by varying the size of the structures themselves. This brings a new design challenge to the design of electronics, as parts of differing values need not necessarily be made the same size. Layouts for devices have the potential to shrink dramatically at the cost of increasing the complexity of the design. However, should size not be a factor, then modules of the same size can easily be made for more simple design constraints by taking the size of the largest part, and populating the lattice around the smaller ones with neutral voxels to build them up to the same size.

With a single type of piece, any shape or geometry can be made. Adding a conducting element means that not only can any shape be built, but also any arbitrary conductive pathway through the shape. Passive electrical components like inductors, capacitors, and strip-line antennas can be made. FIGS. 8, 9B, and 11, for example, show a capacitor (FIG. 8) and inductors (FIGS. 9A and 11) made from press-fit conducting and insulating pieces.

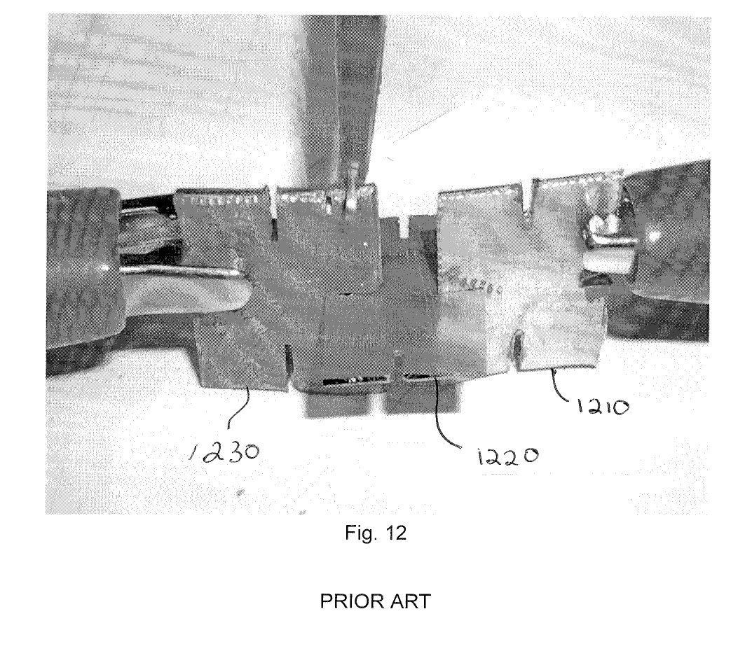

Adding a resistive element means that any passive component can be made, and adding semiconducting pieces means that all active components, such as diodes and transistors, can be fabricated. Perhaps the first example of an active electronic component made entirely from digital material was the approximately 1 cm wide press-fit, GIK diode ohmic junction created by Popescu using copper 1210, N-doped silicon 1220, and lead 1230 GIK digital material parts, as shown in FIG. 12. This proved that active electronics can be built with digital materials. Testing has shown that the diode shown in FIG. 12 functions more or less equivalently to a standard commercial diode. With these active components comes digital logic and the ability to make really interesting computer architectures.

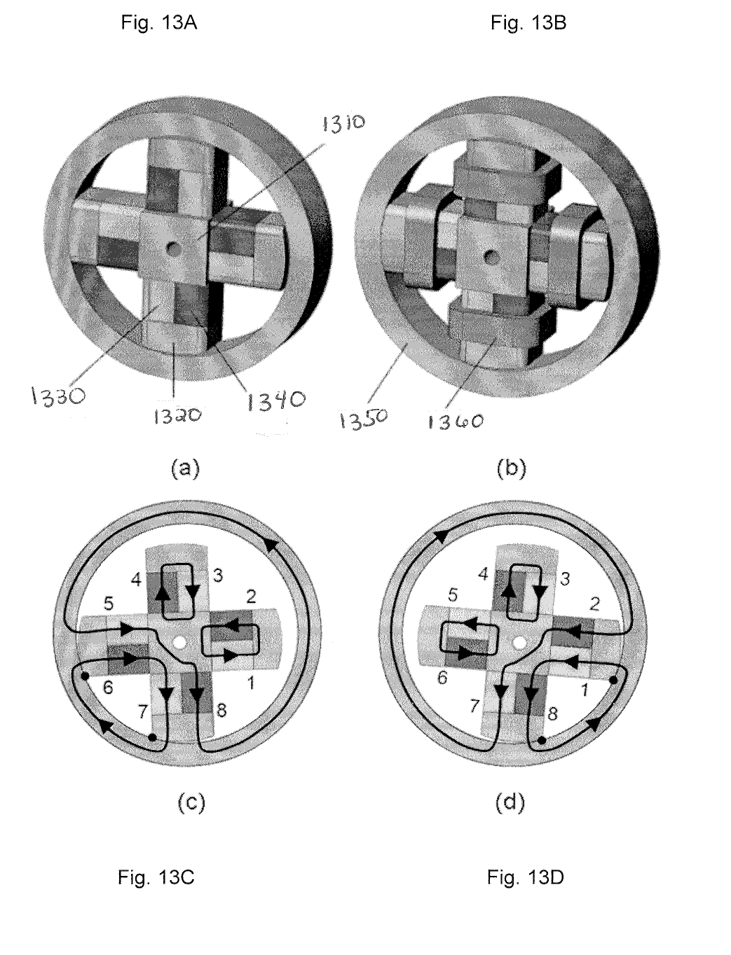

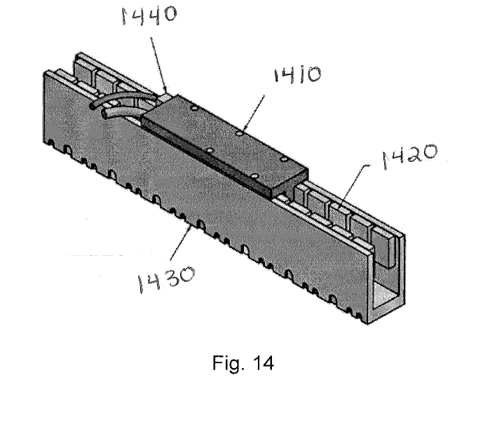

If a magnetic voxel is added to the set of parts, embedded actuators for microrobots can be made (FIGS. 13A-D), as well as new types of distributed actuators (FIG. 14). Seen in FIGS. 13A-D is an exemplary embedded actuator composed of digital materials and having stator core 1310, stator tip 1320, AlNiCo magnet 1330, NdFeB magnet 1340, rotor 1350, and coil 1360. Seen in FIG. 14 is an exemplary distributed actuator composed of digital materials and having coil assembly 1410, fixed magnets 1420, magnet channel assembly 1430, and hall effects 1440.

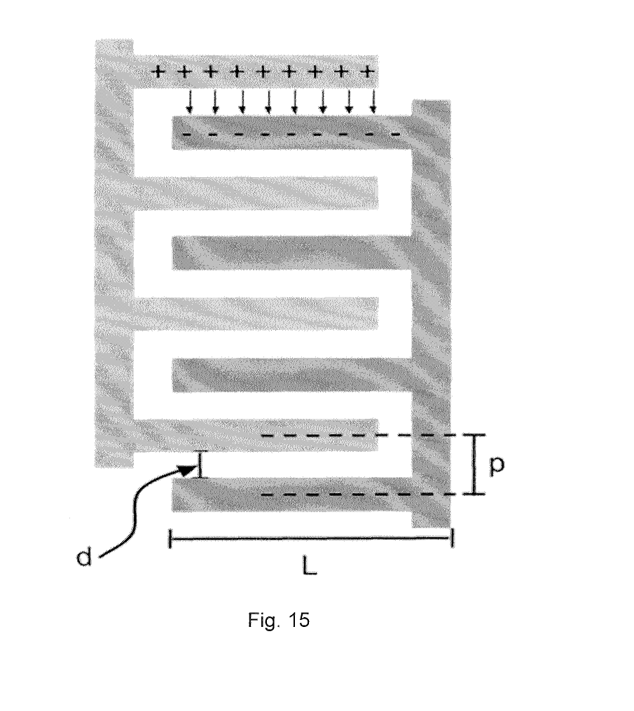

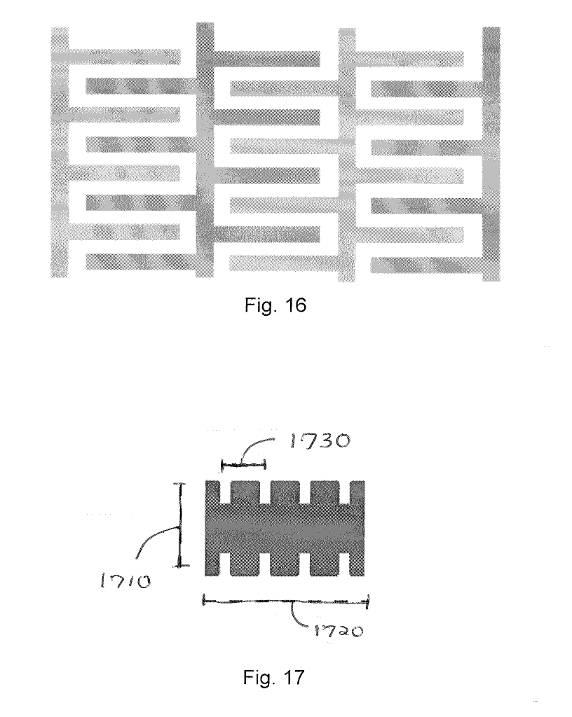

FIG. 15 depicts an exemplary schematic of an interdigitated capacitor made up of discrete voxels. This kind of capacitor makes good use of space and is easily implemented on a Lego™-GIK-type lattice. It can be easily tiled in any dimension (x, y, or z). FIG. 16 depicts simple tiling in the x and y directions for the capacitor of FIG. 15.

The capacitance of a single unit capacitor can be found using the relationship: C=e*A/d. For a unit consisting of 6 conductive parts, this capacitance is roughly 10*e. Because there is a relationship between L and d for the Lego™-GIK, the capacitance per unit scales linearly with the characteristic spacing of the parts (d). However, because volume decreases with the cube of the characteristic spacing, there are large wins in efficiency when scaling down. To create a 1 uF capacitor requires on the order of 10 million parts. To create a 1 nF capacitor requires on the order of 10 thousand parts. To create a 1 pF capacitor requires on the order of 10 parts. This suggests that a capacitance in the pF to nF range could be created as a prototype, given that it is only feasible to put together a discrete capacitor with order 10 parts by hand.

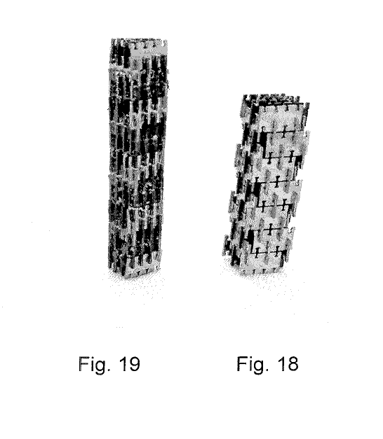

FIG. 17 depicts the voxel used for the prototype capacitor and inductor implementations shown in FIGS. 18 and 19, respectively. The dimensions of the voxel are a height 1710 of 0.12″, width 1720 of 0.2″, and digit spacing 1730 of 0.05″. The exemplary prototype designs are vertical coils, as shown in FIGS. 18 and 19, which complete 1 turn every 4 vertical layers. The devices are small enough to be fairly easy to assemble by hand. It took on the order of an hour to assemble both the capacitor and inductor.

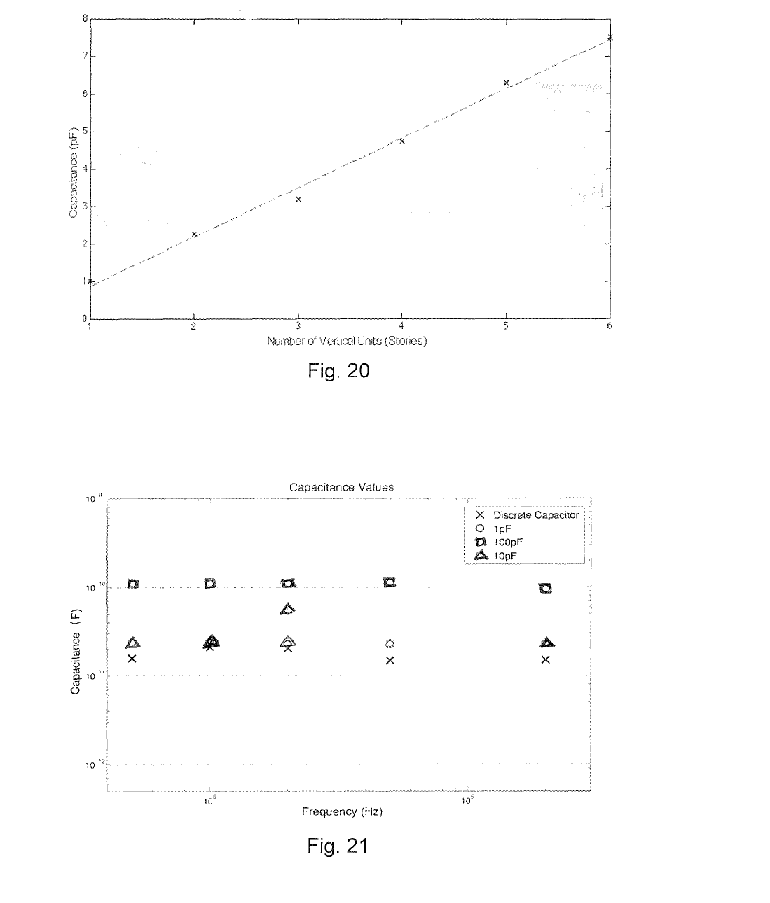

Two different methods were used to test the devices: AT Tiny Step Response and Time-Domain Analysis. For the AT Tiny Step Response test, a capmeter board (David Mellis) was calibrated using a series of known capacitances from 1 pF to 1000 pF. A plot of the capacitance of the discrete capacitor vs. the number of vertical units (capacitance per unit height) is shown in FIG. 20. As seen in FIG. 20, 35 conductive voxels make capacitances on the order of 7 pF, i.e. the device has a capacitance of 1.3 pF per unit height.

Time-domain analysis was performed using o-scope probes on the prototypes in order to observe phase lag and lead. These are specifically designed to reduce the effect of capacitive loading. Capacitance and inductance can be calculated from the amplitude of the input and output waveform as well as the phase shift at a given frequency using the following equations. Here, Va1 in the sinusoidal input, Va2 is the voltage across the capacitor or inductor, and theta is the phase shift.

$$Z = \frac{{V}_{A 2} {R}_{ref}}{\sqrt{{V}_{A 1}^{2} - 2 {V}_{A 1} {V}_{A 2} cos θ + {V}_{A 2}^{2} }}$$

$$α = θ - {tan}^{- 1} \frac{- {V}_{A 2} sin θ}{{V}_{A 1} - {V}_{A 2} cos θ}$$

Then, for a capacitor,

$$C = \frac{- 1}{2 π f Z sin α}$$

and for an inductor,

$$L = \frac{Z sin ( ∝ )}{2 π f}$$

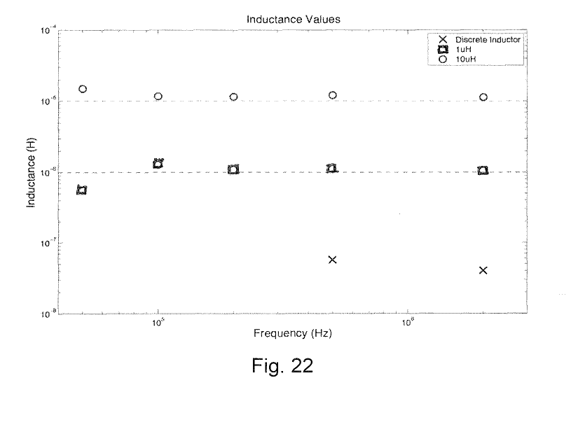

The calculations were made at a range of frequencies from 50 kHz to 10 MHz. The results are shown in FIG. 21. The time-domain analysis was not nearly as sensitive as the step response test was for small capacitances. Its inability to measure below 20 pF leads to the belief that this is a capacitive loading issue resulting from the measurement setup (e.g. probes). The time-domain analysis did much better with the inductors, as seen in FIG. 22. At low frequencies, the discrete inductor attenuated the entire signal but let some signal through at higher frequencies.

It is also possible to discretely assemble functional passive circuit components from digital materials. Furthermore, from the same set of parts it is possible to “program” phase-lag or phase-lead into the structure depending on the placement of the parts. There are significant benefits that come from scaling down the part size since capacitance scales with the characteristic length but volume scales with the cube of the characteristic length. The inductor geometry presented here is not entirely ideal; it is possible that introducing a new part-type could solve the problem of spatial-density for the inductor.

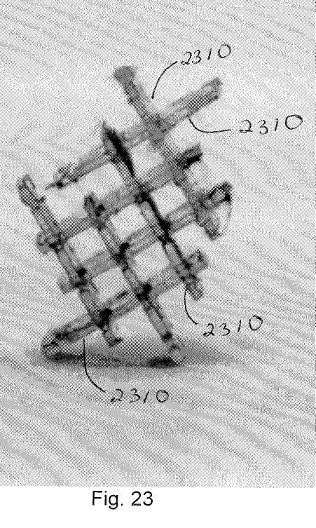

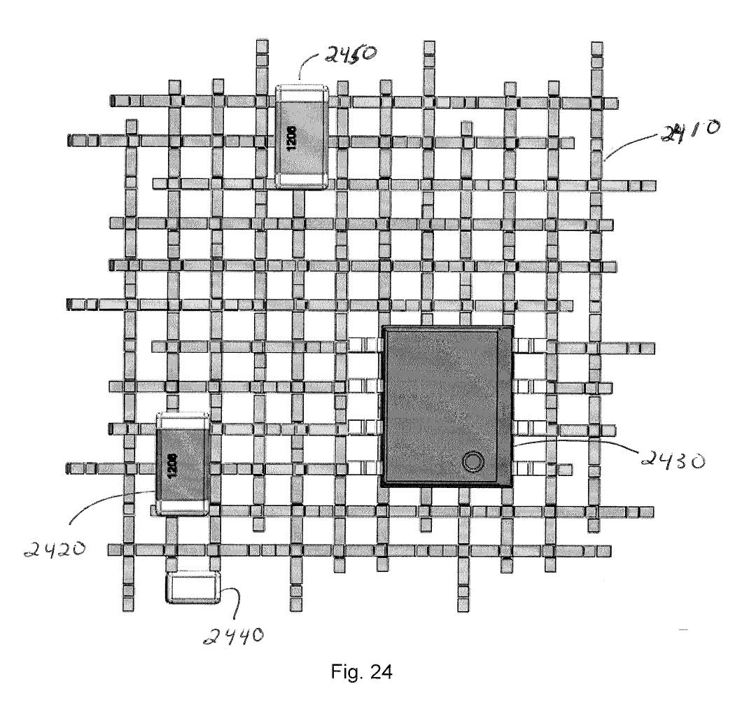

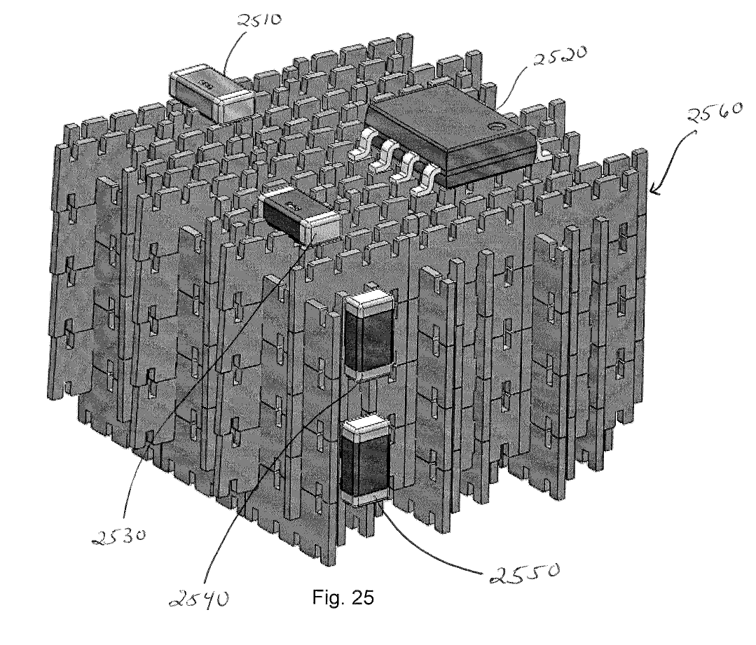

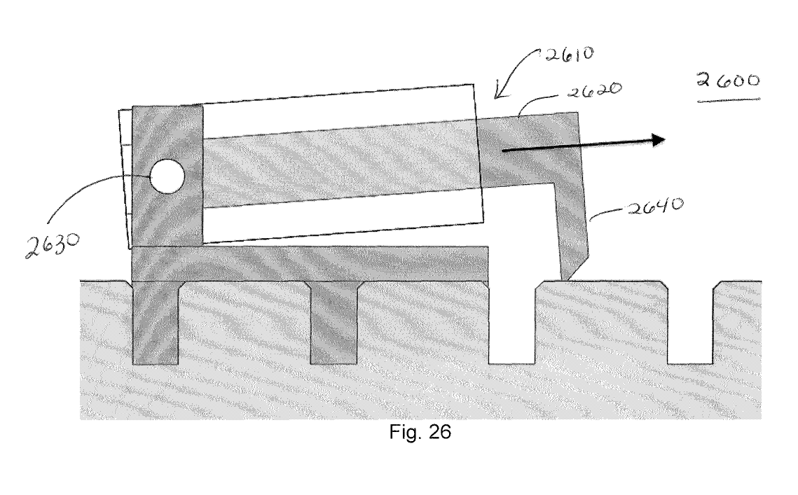

In an exemplary embodiment, circuit boards were made out of press-fit parts. With just a conductive and insulating element, it is possible to fabricate any arbitrary electrical network. FIG. 23 is a magnified view of a portion of an exemplary circuit lattice constructed using the voxel 2310 of FIG. 17. The width of the segment shown is less than 5 mm. The brass and plastic voxels (FIG. 17) were machined with a 10 mil endmill and were arranged specifically to create the necessary conductive pathways between conventional surface mount components. FIG. 24 is a schematic of an exemplary circuit lattice 2410 constructed using the voxel of FIG. 17 and populated by electronic components 2420, 2430. 2440, 2450. FIG. 25 is a schematic of an exemplary 3-dimensional circuit lattice constructed using the voxel of FIG. 17. As can be seen in FIG. 25, components 2510, 2520, 2530, 2540, 2550 can sit on any face of the 3D circuit board 2560, not just on discrete layers. This allows for higher density circuits than would be possible with conventional multi-layer boards.

This example demonstrates a very practical use-case for micro-scale automated assembly. The prototype board was assembled with tweezers and is a snap-together microcontroller board that can be programmed just like any other circuit. Electromagnetic digital materials offer a method to construct electromagnetic structures that are error-correcting, fully recyclable, and can be more precise than the machines that assemble them, because, using a finite set of parts (conductive, resistive, and insulating), any passive electromagnetic structure can be built. However, the means to make electromagnetic structures at the moment (namely, by hand) is excessively slow and makes building large structures infeasible.

The advantages of scaling down the voxel sizes to micro-scale will be clear to one of skill in the art. In order to do this, advances in the methods of automated assembly are required. One preferred approach is to create assemblers that are smaller than the objects they assemble. They work collectively (as a swarm), each assembler placing one part at time as they crawl over the object being assembled.

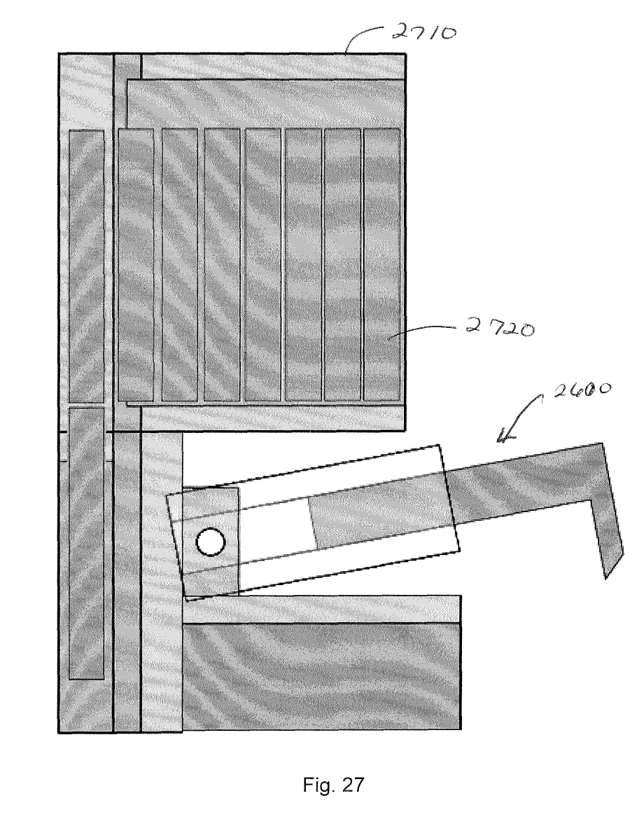

An example of such an assembler is disclosed in U.S. Provisional Pat. App. Ser. No. 61/773,717, filed Mar. 6, 2013. The assembler is a simple robot that crawls on the object being built and deposits one part at a time. The process is made parallel, with multiple robots working simultaneously. FIG. 26 depicts an exemplary embodiment of such a digital inchworm assembler 2600, having a ratchet-type mechanism 2610 and exhibiting single degree-of-freedom ratchet-type locomotion. Arm 2620 can move in and out, and passive (non-actuated) pivot 2630 enables arm 2620 to slide over and down the discrete tiles. By having chamfer 2640 on the arm end-effector and a passive hinge joint, the single degree of freedom enables a complex motion that either pushes or pulls the digital inchworm across the lattice. FIG. 27 depicts the inchworm assembler of FIG. 26 with part dispenser 2710 (and parts 2720).

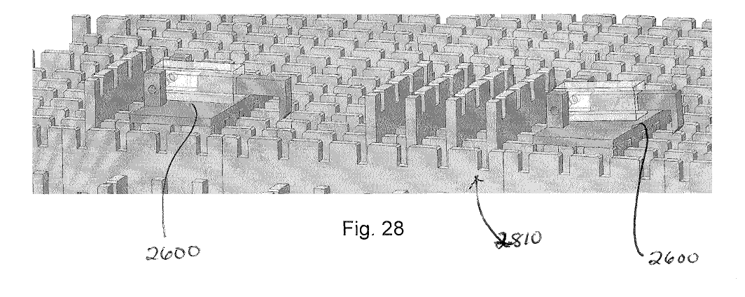

FIG. 28 depicts two of the digital inchworm assemblers 2600 of FIG. 26 in place, constructing a circuit lattice 2810. Assemblers 2600 press-fit into lattice 2810, so they act on local rather than global coordinates and errors (below a certain threshold) are corrected as they go. Because the precision is in embedded in the material, rather than in the assembler itself, the assemblers can be very simple machines which are just precise enough to move from one position on the lattice to another. Furthermore, since the assemblers are much smaller than the objects they make, the scheme is scalable to any build volume, so that in order to assemble something more quickly or to make something larger, all that is required is to add more assemblers.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. An electromagnetic digital material, comprising:
a set of voxels, the set of voxels comprising one or more subsets of identical voxels,
wherein each voxel in the set is assembled, or adapted to be assembled, into a structure according to a regular physical geometry,
wherein a majority of the voxels in the set are each reversibly connected, or adapted to be reversibly connected, to at least two other voxels in the set according to the regular physical geometry,
wherein at least some of the voxels in the set are composed of electromagnetically active materials,
wherein each voxel in the set is assembled, or adapted to be assembled, into the structure according to an electromagnetic geometry, and
wherein a majority of the voxels in the set are each reversibly connected, or adapted to be reversibly connected, to at least two other voxels in the set according to the electromagnetic geometry.

2. The electromagnetic digital material of claim 1, wherein at least some of the voxels in the set differ in material composition or property from at least another of the voxels in the set.

3. The electromagnetic digital material of claim 2, wherein at least some of the voxels in the set are made from an insulating material and some of the voxels in the set are made from a conducting material.

4. The electromagnetic digital material of claim 3, wherein at least some of the voxels in the set are made from resistive, semiconductor, or magnetic materials.

5. The electromagnetic digital material of claim 1, wherein at least some of the voxels in the set are arranged into a set of multi-voxel parts and the multi-voxel parts are assembled, or adapted to be assembled, into the structure according to a multi-voxel part regular physical geometry and the electromagnetic geometry.

6. The electromagnetic digital material of claim 1, wherein the voxels in the set are reversibly connected, or adapted to be reversibly connected, by press-fit connections.

7. The electromagnetic digital material of claim 1, wherein at least some of the subsets of voxels are of differing shapes and wherein voxels of differing shapes are connectable to each other.

8. The electromagnetic digital material of claim 7, wherein at least some of the voxels in the set are connectors configured for connecting others of the voxels in the set to each other in order to assemble two- and three-dimensional structures.

9. An electromagnetic structure, the electromagnetic structure comprising electromagnetic digital material, the electromagnetic digital material comprising:
a set of voxels, the set of voxels comprising one or more subsets of identical voxels, wherein:
each voxel in the set is assembled, or adapted to be assembled, into the electromagnetic structure according to a regular physical geometry;
a majority of the voxels in the set are each reversibly connected, or adapted to be reversibly connected, to at least two other voxels in the set according to the regular physical geometry;
at least some of the voxels in the set are composed of electromagnetically active materials;
each voxel in the set is assembled, or adapted to be assembled, into the electromagnetic structure according to an electromagnetic geometry; and
a majority of the voxels in the set are each reversibly connected, or adapted to be reversibly connected, to at least two other voxels in the set according to the electromagnetic geometry.

10. The electromagnetic structure of claim 9, wherein at least some of the voxels in the set differ in material composition or property from at least another of the voxels in the set.

11. The electromagnetic structure of claim 9, wherein the electromagnetic structure is a circuit lattice.

12. The electromagnetic component of claim 10, wherein the electromagnetic structure is an electronic device.

13. The electromagnetic structure of claim 10, wherein at least some of the voxels are composed of magnetic materials and the electromagnetic structure is a motor.

14. The electromagnetic structure of claim 9, wherein at least some of the voxels in the set are arranged into a set of multi-voxel parts and the multi-voxel parts are assembled, or adapted to be assembled, into the electromagnetic structure according to a multi-voxel part regular physical geometry and the electromagnetic geometry.

15. An automated process for fabricating an electromagnetic structure from electromagnetic digital material, comprising
assembling a set of voxels, wherein at least some of the voxels in the set are composed of electromagnetically active materials, into the electromagnetic structure by:
reversibly connecting a majority of the set of voxels to each other, each of the voxels in the set being reversibly connected, or adapted to be reversibly connected, to at least two other voxels in the set according to a regular physical geometry and an electromagnetic geometry; and
assembling the reversibly connected voxels into the electromagnetic structure according to the regular physical geometry and the electromagnetic geometry, wherein the assembled reversibly connected set of voxels forms the electromagnetic structure.

16. The automated process of claim 15, wherein the automated process is controlled by a specially adapted processor implementing a computer algorithm.

17. The automated process of claim 15, wherein the electromagnetic properties of the electromagnetic structure produced by the process may be tuned by changing one or more of the following: the ratio of different types of voxels used to assemble the electromagnetic structure, the shape of the different types of voxels used to assemble the electromagnetic structure, the material properties of the different types of voxels used to assemble the electromagnetic structure, and the physical geometry of the electromagnetic structure.

18. The automated process of claim 15, wherein the electromagnetic structure is a circuit lattice.

19. The automated process of claim 15, wherein the electromagnetic structure is an electronic device.

20. The automated process of claim 15, wherein at least some of the voxels are composed of magnetic materials and the electromagnetic structure is a motor.
